(19) United States
(12) Patent Application Publication
(10) Pub. No.: US 2006/0099291 A1
(43) Pub. Date: May 11, 2006

(54) Air ring with circumferentially adjustable air flow

(76) Inventors: Mirek Planeta, Mississauga (CA); Nghia (Paul) Dang, Mississauga (CA); Narendra Sachdev, Brampton (CA)

Correspondence Address: GOWLING, LAFLEUR HENDERSON LLP, ONE MAIN STREET WEST, HAMILTON, ON, L8P 4Z5, CA

(21) Appl. No.: 11/246,196

(22) Filed: Oct. 11, 2005

Related U.S. Application Data
(60) Provisional application No. 60/617,030, filed on Oct. 12, 2004.

(51) Int. Cl. B29C 47/00

(52) U.S. Cl. 425/326.1; 425/378.1

(57) ABSTRACT

An air ring for supplying cooling air to a hot extruded plastic film after the film has been extruded from an annular extrusion die at an elevated temperature has an annular body which in use surrounds hot tubular plastic film after the film has left the extrusion die. The annular body has an annular plenum chamber to which air is supplied from an external source, and a circumferentially extending series of separate air passages communicating with the plenum chamber for receiving cooling air therefrom and extending radially inwardly to respective separate orifices which in use of the air ring are adjacent to and surround the hot tubular film. Separate adjustors individually control the flow of air from the plenum chamber to respective air passages and associated orifices, whereby air flow from each orifice impinges on a discrete circumferentially extending portion of the tubular film in a manner substantially independently of air flow from the other orifices.

### RELATED APPLICATION

This application claims priority from U.S. Provisional Patent Application No. 60/617030 filed Oct. 12, 2004, the contents of which are hereby incorporated herein by reference.

### FIELD OF INVENTION

This invention relates to air rings for supplying cooling air to a hot extruded plastic film after the film has been extruded from an annular extrusion die.

### BACKGROUND OF INVENTION

Many different types of air rings have been proposed in the past, see for example U.S. Pat. No. 5,804,221 (Planeta et al.) issued Sep. 8, 1998, the contents of which are hereby incorporated herein by reference, which describes controlling air flow at different circumferential locations to adjust the gauge (thickness) of the extruded film. However, because of ever increasing need for high quality film made from different plastic materials with different physical properties, there is a requirement for improved airflow control at different circumferential locations.

It is therefore an object of the invention to provide an air ring which enables airflow at different circumferential locations to be controlled in an improved manner.

### SUMMARY OF INVENTION

According to the invention, an air ring has an annular body which in use surrounds hot tubular plastic film after the film has left the extrusion die, said annular body having an annular plenum chamber to which air is supplied from an external source, a circumferentially extending series of separate air passages communicating with the plenum chamber for receiving cooling air therefrom and extending radially inwardly to respective separate orifices which in use of the air ring are adjacent to and surround the hot tubular film, and separate adjustors for individually controlling the flow of air from the plenum chamber to respective air passages and associated orifices, whereby air flow from each orifice impinges on a discrete circumferentially extending portion of the tubular film substantially independently of air flow from the other orifices.

The annular body may also have an annular air passage which receives air from the plenum chamber and extends radially inwardly to an annular orifice which in use is adjacent to the tubular film.

The circumferentially extending series of separate air passages and associated orifices may be formed by an attachment to the annular body, with the separate air passages receive cooling air from the annular air passage, said adjusters controlling flow of cooling air from the annular air passage to the respective separate air passages. Thus, the invention may be retrofitted to suitable existing air rings.

A circumferentially extending series of radially inwardly directed attachments may be secured to the underside of the annular body, said attachments cooperating with the annular body to form an air chamber and said air passage, the annular body having a circumferentially extending series of apertures in the bottom thereof providing communication between the air chamber and the said passage, the associated adjustor having a valve member slideably mounted therein adjacent the aperture whereby movement of the valve member controls the size of the aperture to vary air flow to the associated orifice.

An air ring in accordance with the invention may be a sole air ring, a primary air ring located below a secondary air ring, or a secondary air ring located above a primary air ring. Also, the invention may be utilized with both a primary air ring and a secondary air ring.

### DESCRIPTION OF DRAWINGS

Embodiments of the invention will now be described, by way of example, with reference to the accompanying drawings, of which;

FIG. 1 is a sectional side view of tubular plastic film being extruded from an annular extrusion die and being cooled by a primary air ring not in accordance with the invention, a secondary air ring in accordance with one embodiment of the invention and internal bubble cooling equipment;

FIG. 2 is a somewhat diagrammatic bottom view of the circumferentially extending series of separate air passages of the secondary air ring;

FIG. 3 shows a primary air ring in accordance with a second embodiment of the invention, a secondary air ring not in accordance with the invention and with the internal bubble cooling equipment omitted;

FIG. 4 is similar to FIG. 3 but with the secondary air ring also omitted;

FIG. 5 is similar to FIG. 4 but with a slightly different primary air ring;

FIG. 6 is similar to FIG. 5 but includes internal bubble cooling equipment; and

FIG. 7 is similar to FIG. 4 but with a secondary air ring not in accordance with an embodiment of the invention.

### DESCRIPTION OF PREFERRED EMBODIMENTS

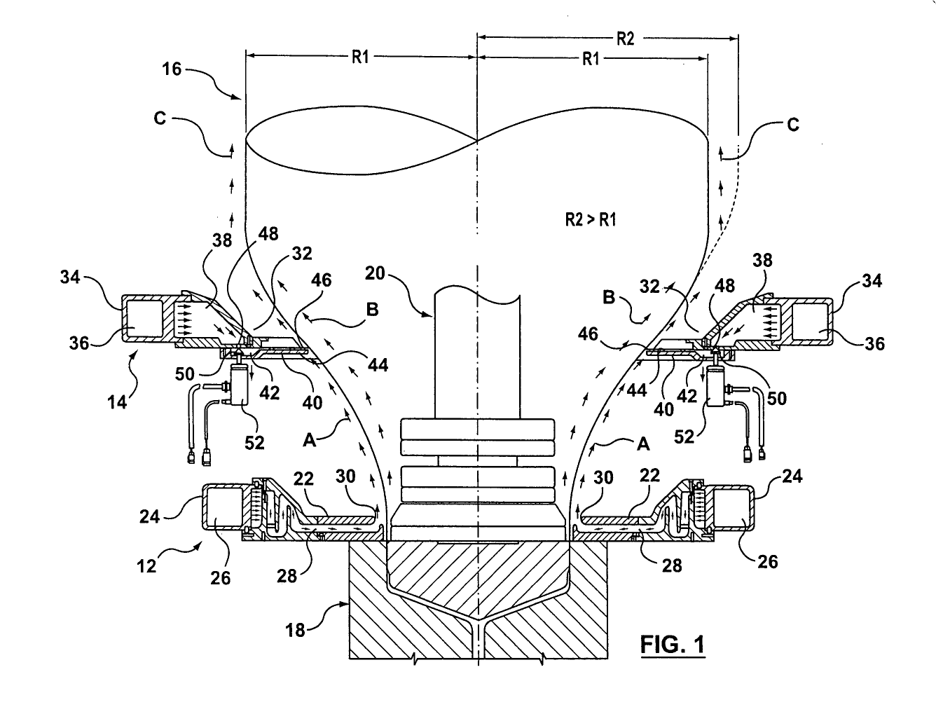

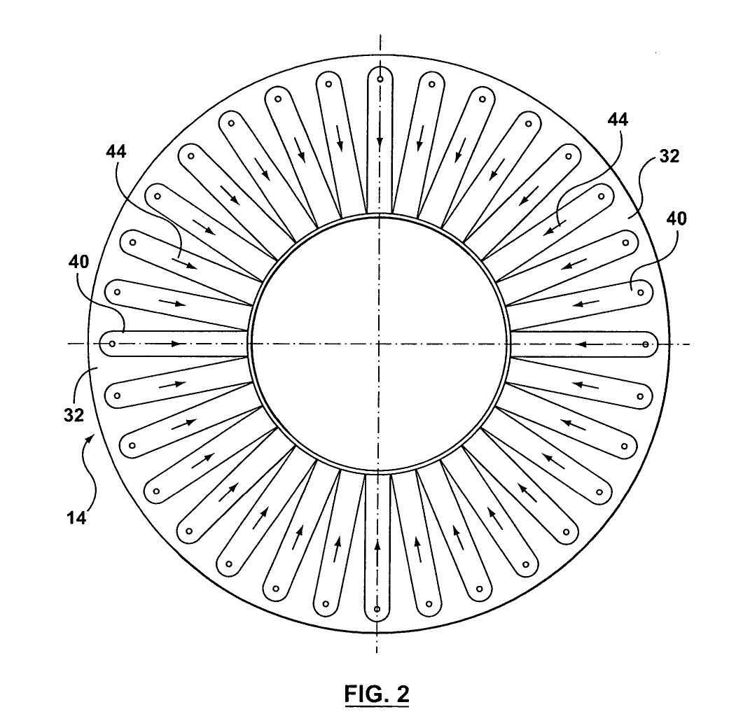

Referring first to FIGS. 1 and 2 of the drawings, a primary air ring 12 and a secondary air ring 14 are provided to cool tubular plastic film 16 after extrusion from an annular extrusion die 18. Internal bubble cooling equipment 20 is also provided. The primary air ring 12 is of known construction and comprises an annular body 22 having its radially inner edge portion mounted on the top of the extrusion die 18. An annular housing 24 forming a plenum chamber 26 surrounds and is secured to the radially outer edge of the annular body 22. The plenum chamber 26 is supplied with cooling air from an external source (not shown), and the cooling air passes in a radially inward direction from the plenum chamber 26 through an annular passage 28 in the air ring body 22 to an annular orifice 30 at its radially inner edge adjacent the tubular film 16 so that air from the orifice 30 flows upwardly adjacent the film 16, as indicated by the arrows A. The internal bubble cooling equipment 20 is also of known construction, with cooling air therefrom travelling upwardly on the inside of the tubular film 16, as indicated by the arrows B.

The secondary air ring 14 is in accordance with an embodiment of the invention and is mounted in known manner at a location spaced above the primary air ring 12, preferably just below the frost line of the tubular film 16 as will be readily understood by a person skilled in the art. The secondary air ring 14 has an annular body 32 with an annular housing 34 forming a plenum chamber 26 surrounding and secured to the radially outer edge of the annular body 32, the plenum chamber 26 being supplied with cooling air from an external source (not shown). Air flows from the plenum chamber 26 into an annular air chamber 38 in the annular body 32.

A circumferentially extending series of radially inwardly directed attachments 40 are secured to the underside of the annular body 32. Each attachment 40 cooperates with the annular body 32 to form an air chamber 42 and an air passage 44 extending therefrom to an orifice 46 at the radially inner edge of the annular body 32 and the attachment 40. The annular body 32 has a circumferentially extending series of apertures 48 in the bottom thereof, each aperture 48 providing communication between the air chamber 38 and an air chamber 42. Also, each attachment 40 carries a valve member 50 slidably mounted for vertical movement therein adjacent the aperture 48. Vertical movement of each valve member 50 is controlled by a respective one of a circumferentially extending series of remotely controlled actuators 52 which operate to cause the respective valve member 50 to adjust the size of the aperture 48 and hence the amount of air passing from the air chamber 38 to an air chamber 42 and subsequently to an orifice 46. The actuators 52 may be of any suitable type, for example electric or piezoelectric motors, bimetallic actuators, solenoid coils, pressure regulators or flow valves.

Thus, the amount of cooling air flowing from each orifice 46 of the secondary air ring 14 from the plenum chamber 36 and air chamber 38 is adjustable substantially independently of air flow from other orifices by means of the respective remotely controlled actuator 52. Such adjustment may be pre-programmed for a particular kind of film being extruded or may be automatically adjusted in response to circumferential variations in thickness of the film as sensed by an annular thickness sensor (not shown but known to persons skilled in the art). An increase in radius of the bubble 16 at any particular circumferential location from R1 to R2 as a result of adjustment of the amount of cooling air flowing from the orifice 46 causes the bubble 16 to have a thinner gauge at that location. It will be noted that cooling air from each orifice 46 merges with cooling air from the primary air ring 12 to form a cooling air flow as indicated by arrows C.

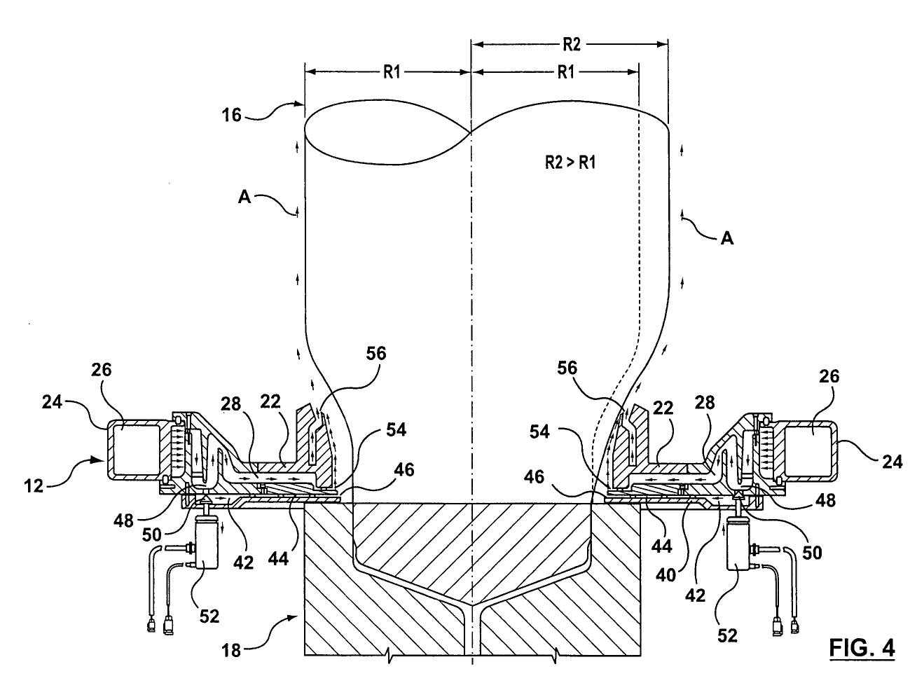

Various other alternative arrangements will now be described. In the arrangement shown in FIG. 4, the primary air ring 12 is provided with the attachments 40 and actuators 52 instead of the secondary air ring as before. Also, the internal bubble cooling equipment has been omitted. The apertures 48 are provided in the annular body 22 of the primary air ring 12. Also, the radially inner edge of the primary air ring 12 has been modified to provide two annular orifices 54, 56 instead of the single annular orifice 30 shown in FIG. 1. The secondary air ring 60 has an annular housing 64 providing a plenum chamber 66, and the annular body 68 has an air chamber 70 with an air passage 72 leading to two orifices 74, 76.

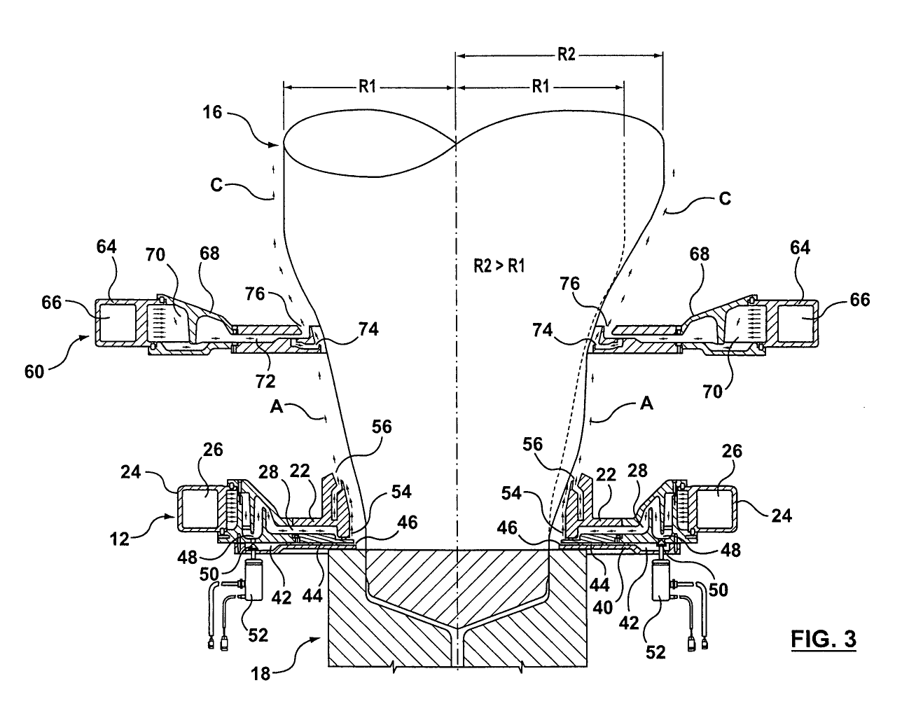

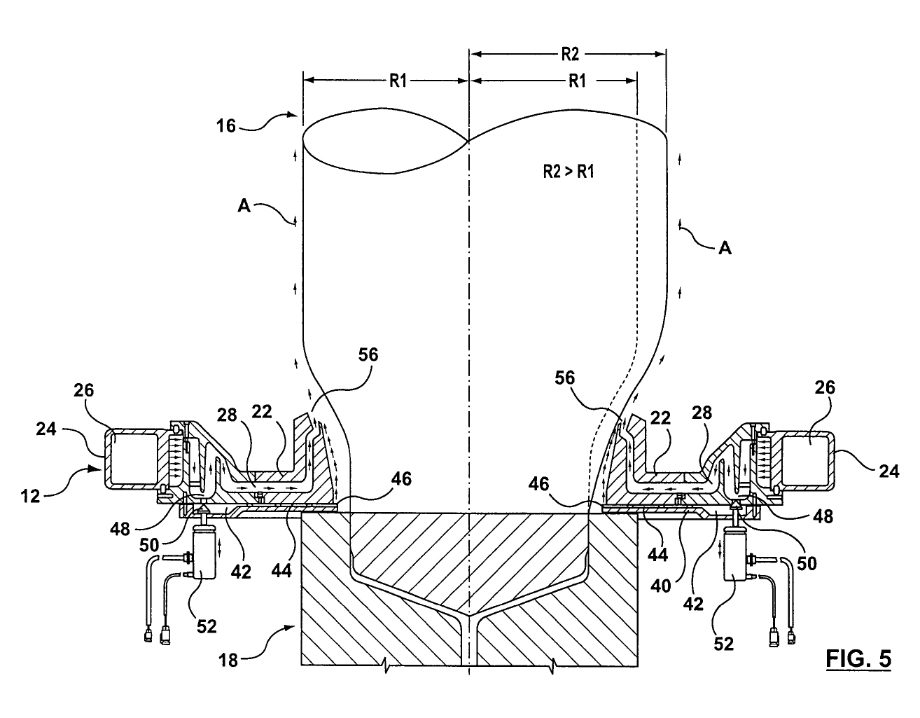

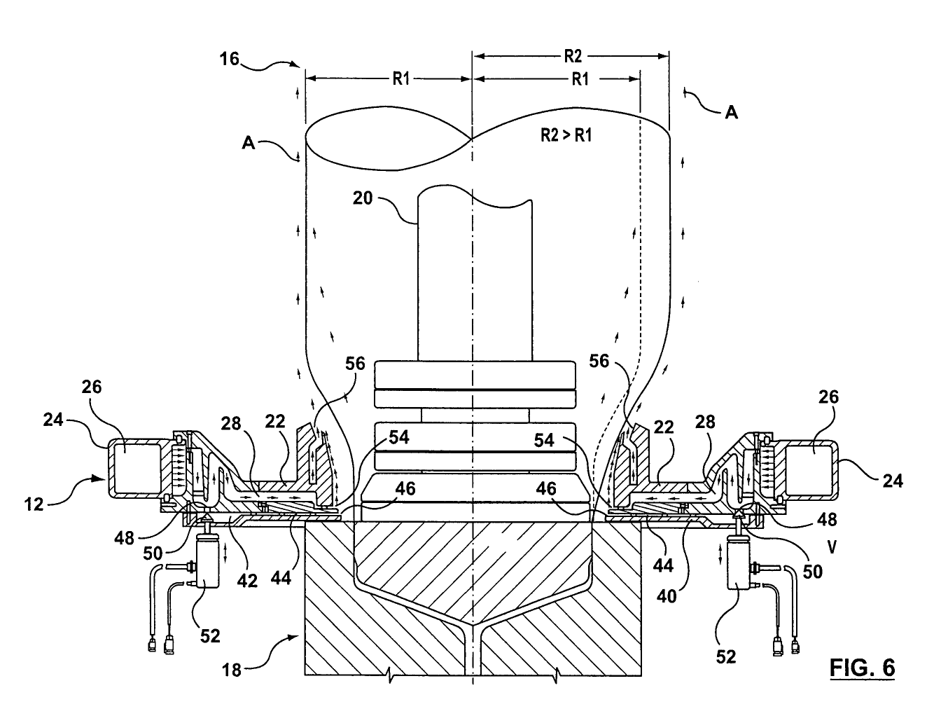

The arrangement shown in FIG. 4 is similar to that in FIG. 3, except that the secondary air ring has been omitted. FIG. 5 is similar to FIG. 4, except that the annular orifice 54 has been omitted. FIG. 6 is the same as FIG. 4, except that the internal bubble cooling equipment 20 is provided.

The advantages of the invention will now be readily apparent to a person skilled in the art from the foregoing description of preferred embodiments. Other embodiments will also now be readily apparent. For example, both the primary air ring and secondary air ring may be in accordance with the invention. It will be especially noted that the invention can be retrofitted to suitable existing air rings by securing attachments 40 with actuators 52 and valve member 50 thereto and providing the apertures 48 in the existing air ring. For example, as shown in the embodiments shown above, the apertures 48 may be provided in the bottom of an existing air ring, with the attachments 40 being secured to the bottom of the air ring. The scope of the invention is described in the appended claims.

1. An air ring for supplying cooling air to a hot extruded plastic film after the film has been extruded from an annular extrusion die at an elevated temperature, said air ring having
an annular body which in use surrounds hot tubular plastic film after the film has left the extrusion die, said annular body having an annular plenum chamber to which air is supplied from an external source,
a circumferentially extending series of separate air passages communicating with the plenum chamber for receiving cooling air therefrom and extending radially inwardly to respective separate orifices which in use of the air ring are adjacent to and surround the hot tubular film, and
separate adjustors for individually controlling the flow of air from the plenum chamber to respective air passages and associated orifices, whereby air flow from each orifice impinges on a discrete circumferentially extending portion of the tubular film in a manner substantially independently of air flow from the other orifices.

2. An air ring according to claim 1 wherein the body also has an annular air passage which receives air from the plenum chamber and extends radially inwardly to an annular orifice which in use is adjacent to the tubular film.

3. An air ring according to claim 2 wherein the circumferentially extending series of separate air passages and associated orifices are formed by an attachment to the annular body and the separate air passages receive cooling air from the annular air passage, said actuators controlling flow of cooling air from the annular air passage to the respective separate air passages.

4. An air ring according to claim 3 wherein a circumferentially extending series of radially inwardly directed attachments are secured to the underside of the annular body, said attachments cooperating with the annular body to form an air chamber and said air passage, the annular body having a circumferentially extending series of apertures in the bottom thereof providing communication between the air chamber and the said passage, the associated adjustor having a valve member slideably mounted therein adjacent the aperture whereby movement of the valve member controls the size of the aperture to vary air flow to the associated orifice.

5. A plastic film extrusion assembly including an annular extrusion die for extruding tubular plastic film and an air ring in accordance with claim 1 surrounding the tubular film above the extrusion die.

6. A film extrusion assembly according to claim 5 wherein the air ring in accordance with claim 1 is a primary air ring and a secondary air ring is provided above the primary air ring.

7. A film extrusion assembly according to claim 5 wherein the air ring in accordance with claim 1 is a secondary air ring located above a primary air ring.

8. A film extrusion assembly according to claim 5 wherein a primary air ring in accordance with claim 1 is located above the extrusion die and a secondary air ring in accordance with claim 1 is located above the primary air ring.
